(19) United States
(12) Patent Application Publication
(10) Pub. No.: US 2012/0152760 A1
(43) Pub. Date: Jun. 21, 2012

(54) WATER TREATMENT METHOD AND SYSTEM

(75) Inventor: Valrie Dene Robinson, Delahey (AU)

(73) Assignee: AQUATECH WATER PURIFICATION SYSTEMS PTY LTD, Braeside, Victoria (AU)

(21) Appl. No.: 13/379,730

(22) PCT Filed: Jun. 22, 2010
(86) PCT No.: PCT/AU2010/000773

§ 371 Date: Feb. 29, 2012

Related U.S. Application Data
(60) Provisional application No. 61/219,832, filed on Jun. 24, 2009.

(51) Int. Cl. C02F 1/461; C25B 9/00

(52) U.S. Cl. 205/742; 204/242; 204/230.2

(57) ABSTRACT

The present invention provides water treatment systems and methods. An electrolysis based water treatment system according to an embodiment of the invention includes a reservoir for holding the water to be treated, two or more electrodes of two or more types, each type of electrode having a different material composition, and positioned to be at least partially immersed in water held in the reservoir, and a power supply adapted to power the electrodes. The electrodes used and the polarity of current applied to power the electrodes for different electrolysis phases are selected based on the material composition of the electrodes.

### CROSS REFERENCE TO RELATED APPLICATION

This application is based on and claims the benefit of the filing date of U.S. provisional patent application Ser. No. 61/219,832 filed 24 Jun. 2009, the contents of which is incorporated herein by reference in its entirety.

### FIELD OF THE INVENTION

The field of the invention is water treatment and in particular removal of impurities from water using electrolysis based methods.

### BACKGROUND OF THE INVENTION

Supply of clean water is vital for human and environmental health. As ready supplies of clean water become scarce or inadequate to meet human and environmental requirements, water purification becomes increasingly important. In particular the ability to remove impurities from polluted water to enable this water to be safely released into the environment or reused is a great value in industry and households.

Electrolysis based water purification methods are one known method for removal of impurities form water. Two known electrolysis based water purification methods are electroflocculation and electrocoagulation. Each of these methods are based on sacrificial electrodes being used to generate a coagulating agent in the form of ions which bond with water borne impurities. In electroflocculation bubbles released from the electrodes during electrolysis float the coagulated impurities to the surface of the water for removal. In electrocoagulation, the coagulated impurities are filtered from the water or allowed to settle once the water has been treated. There are significant known problems with both electroflocculation and electrocoagulation which limit the usefulness and commercial viability of these processes.

### SUMMARY OF THE INVENTION

According to one aspect of the present invention there is provided an electrolysis based water treatment system comprising:
a reservoir for holding the water to be treated;
two or more electrodes of two or more types, each type of electrode having a different material composition, and positioned to be at least partially immersed in water held in the reservoir; and
a power supply adapted to power the electrodes
wherein the electrodes used and the polarity of current applied to power the electrodes for different electrolysis phases are selected based on the material composition of the electrodes.

According to another aspect of the present invention there is provided a water treatment system comprising:
a reservoir for holding the water to be treated;
one or more first electrodes having a first material composition positioned to be at least partially immersed in water held in the reservoir;
one or more second electrodes having a second material composition positioned to be at least partially immersed in water held in the reservoir;
a power supply adapted to power the electrodes; and
a controller adapted to selectively control the application of power to two or more electrodes selected from the first and second electrodes to perform one or more electrolysis phases, wherein at least one electrolysis phase is an electrolysis treatment phase wherein at least one electrode provides dissolved ions which act as an attractant for impurities to aid removal of the impurities from the water, and wherein the electrodes and power supply polarity are selected for each electrolysis phase based on electrode composition.

The selection of electrodes for each electrolysis phase can be further based on water treatment requirements and impurities in the water to be treated.

The controller can be adapted to perform at least two electrolysis treatment phases wherein electrodes having a different material composition are powered as anodes for each electrolysis treatment phase.

For example, the electrodes powered as anodes for one electrolysis treatment phase can have a material composition including iron and the electrodes powered as anodes for another electrolysis treatment phase can have a material composition including aluminum.

In an embodiment the electrode powered as an anode in one electrolysis treatment phase is powered as a cathode in another electrolysis treatment phase.

The controller can be further adapted to perform one or more of a pre-treatment electrolysis phase and post-treatment electrolysis phase.

In an embodiment the first electrodes are sterilization electrodes having a material composition adapted to produce water sterilization ions when powered as an anode for an electrolysis phase. For example, the sterilization electrode can be powered as an anode during a post-treatment electrolysis phase.

In an embodiment the material composition of the sterilization electrode includes any one or more of copper and silver.

In some embodiments the first and second electrodes are plates arranged in an array of alternating first and second electrode plates. Some such embodiments further comprise at least two third electrodes having a third non-eroding material composition, wherein the third electrodes are arranged at each end of the array of alternating first and second electrode plates.

In some embodiments the first and second electrode plates are arranged in an array of electrode plates, the array including one or more plates that are not electrically connected to either first or second electrodes or a power supply arranged in the array between at lest two of the first and second electrode plates

Some embodiments of the system further comprise an agitator operable to cause movement in the water and particles and gases therein to aid carriage of ions and impurities away from the electrodes.

The agitator of some embodiments comprises one or more pairs of secondary electrodes disposed below the first and second electrodes and connected to a power supply whereby power supplied to the secondary electrodes causes production of bubbles within the water.

According to another aspect of the present invention there is provided a water treatment method comprising the steps of:
providing water to be treated to a treatment apparatus comprising:
a reservoir for holding the water to be treated;
one or more first primary electrodes having a first material composition; and
one or more second primary electrodes having a second material composition;
wherein each of the primary electrodes are positioned to be at least partially immersed in water held in the reservoir and connected to a power supply adapted to power the electrodes;
selecting two or more of the first and second electrodes and a power supply polarity to apply to the electrodes for performing a first electrolysis phase;
applying power of the selected polarity to the selected electrodes to perform the first electrolysis phase;
selecting a further two or more of the first and second electrodes and a power supply polarity for the second electrolysis phase;
applying power of the selected polarity to the selected electrodes to perform the second electrolysis phase; and
removing the impurities from the water,
   wherein at least one of the first or second electrolysis phase is an electrolysis treatment phase wherein at least one electrode provides dissolved ions which act as an attractant for impurities to aid removal of the impurities from the water, and
   wherein the selection of the electrodes and power supply polarity are selected for each electrolysis phase based on electrode composition.

In an embodiment of the method the step of performing the electrolysis treatment phase includes the step of measuring the current flowing through the electrodes at the beginning of the first phase to power the electrode pairs, calculating a duration for the first phase based on the measured current, volume of water and contaminant load of the water, and ending the first phase after the calculated duration by ceasing to power the electrodes.

### BRIEF DESCRIPTION OF THE DRAWINGS

An embodiment, incorporating all aspects of the invention, will now be described by way of example only with reference to the accompanying drawings in which:

FIG. 1 is an example of a water treatment system according to one embodiment of the present invention

FIG. 2 is an illustrative example of a water treatment system according to an embodiment of the present invention

FIG. 3 is a flowchart of an example of a water treatment method according to an embodiment of the present invention

FIG. 4 is an example of an alternative water treatment system according to an embodiment of the invention

### DETAILED DESCRIPTION

Embodiments of the present invention perform electrolysis based water treatment in a system having two or more types of electrodes, each type having a different material composition, where electrodes used and the polarity of current applied to power the electrodes for different electrolysis phases are selected based on the material composition of the electrodes. The system may optionally include an agitator operable to cause movement in the water and particles and gases therein to aid carriage of ions and impurities away from the electrodes.

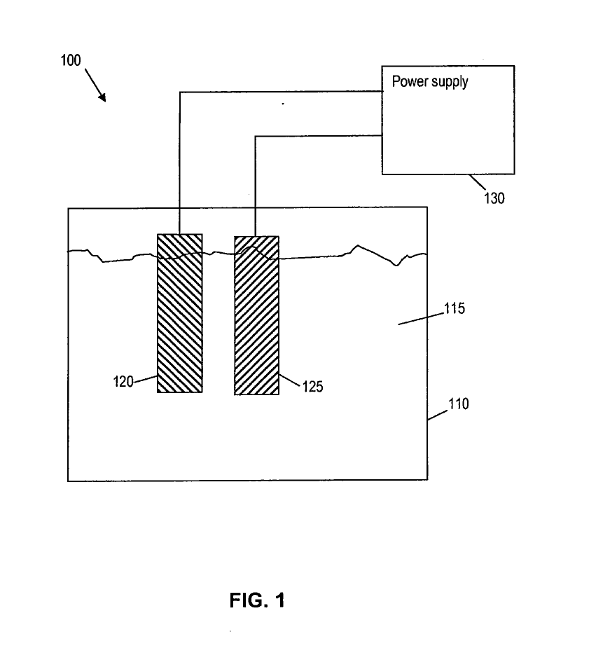

An example of water treatment system is illustrated in FIG. 1. The water treatment system 100 of FIG. 1 comprises a reservoir 110 for holding water 115 to be treated, two or more primary electrodes 120, 125 and a power supply 130. The primary electrodes are of two or more types, with each type having a different material composition. In the illustrated example where there is only one electrode pair the first electrode 120 has a first material composition and the second electrode 125 has a different material composition. Although only one electrode pair 120, 125 is illustrated in FIG. 1, the system may comprise more than two electrodes and more than two electrode types. The electrodes 120, 125 are positioned to be at least partially immersed in water 115 held in the reservoir 110.

The electrodes are selectively used to perform the electrolysis process. The power supply 130 is adapted to selectively power the electrodes 120, 125 to perform at least a first electrolysis phase. The polarity of the power supply is selected for the electrolysis phase based on the material composition of the electrodes 120, 125.

During the electrolysis phase an electrical current is passed between the pair of electrodes 120, 125 in the contaminated water. One electrode will act as a cathode and the other an anode, depending on the polarity of the power supplied to the pair. This causes ions to be generated and released into the water from the electrode acting as the anode for the electrolysis phase. The type of ions released is dependent on the material composition of the anode electrode. Thus, the chemical properties of the released ions and the affect of the treatment phase on the contaminated water will be dependent on the material composition of the anode electrode.

Typically at least one electrolysis phase will be performed where the electrodes and polarity are selected such that one electrode provides dissolved ions which act as an attractant for impurities to aid removal of the impurities from the water. Ion generation can occur at voltages of around 1.7 volts. However, in practice typically voltages of around 4 volts or more are used. During electrolysis oxygen and hydrogen are also generated forming small bubbles also referred to as micro-bubbles which help float the captured contaminants to the surface of the water for removal. The majority of the micro-bubbles are generated from the cathode.

Other electrolysis phases can include phases where electrodes are selected to be driven as anodes to release ions which have water sterilizing properties that aid killing and removal of algae or other live contaminants.

The system can be used to perform two or more electrolysis phases for a batch of contaminated water, wherein two or more types of water treatment are performed. Each electrolysis phase can perform a different type of treatment. Alternatively, some treatment types may be performed more than once during the full treatment process. In some cases whether or not a treatment phase is repeated can be based on feedback on the efficacy of the treatment process. For example this may come from assessment of turbidity or water condition using visual assessment or turbidity meters, chemical testing of the treated water, current measurements during the electrolysis phases, etc.

The material composition of the electrodes for the system can be selected based on the anticipated types of contaminants and the treatment requirement for the system. For example, iron and aluminum electrodes for use as sacrificial anodes in electroflocculation and electrocoagulation systems are known. Iron anodes release ions which replicate the actions of the known chemical flocculant ferric chloride whereas aluminum anodes release ions which replicate the actions of the known chemical flocculant aluminum sulphate. However, known systems use only iron or only aluminum sacrificial electrodes. However, removal of some contaminants can be improved by using a combination of aluminum and ferric flocculants. In known systems this is achieved by using two separate cleaning systems and processes requiring transfer of the treated water through the two systems for treatment.

Embodiments of the present system enable both processes to be completed as different electrolysis phases. For example, with reference to FIG. 1, if electrode 120 is an iron electrode plate and electrode 125 is an aluminum electrode plate. An iron pre-treatment step can be performed by selecting the power supply polarity such that the iron electrode 120 is powered as the anode and the aluminum electrode 125 the cathode. Thus, ferric ions are released into the water to capture the contaminants. The polarity of the power supply can then be changed such that the aluminum electrode becomes the anode and the iron electrode becomes the cathode. Thus, the iron electrode will cease to release ions when it becomes the cathode, and the aluminum anode will release coagulating/flocculating ions.

This system alleviates problems which may occur if separate sets of aluminum and iron electrode pairs are driven separately in the same system. When the iron electrodes are not being driven they simply corrode in the water. Thus, producing further contaminants and providing an environment in which for iron loving bacteria to thrive. Using the iron electrode as a cathode when not in use as an anode prevents corrosion of the electrode.

A further embodiment of the water treatment system includes a controller adapted to selectively control the application of power two or more of the first and second types of electrodes to perform one or more electrolysis phases. At least one electrolysis phase is an electrolysis treatment phase wherein at least one electrode provides dissolved ions which act as an attractant for impurities to aid removal of the impurities from the water. The selection of the electrodes and power supply polarity are selected for each electrolysis phase based on electrode composition. The controller can be included in or connected to the power supply, for example a programmable logic controller or microprocessor implemented as part of the power supply.

The selection of electrodes for each electrolysis phase can be further based on water treatment requirements and impurities in the water to be treated.

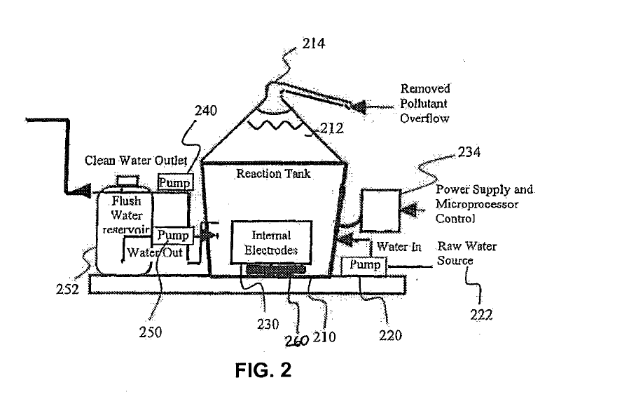

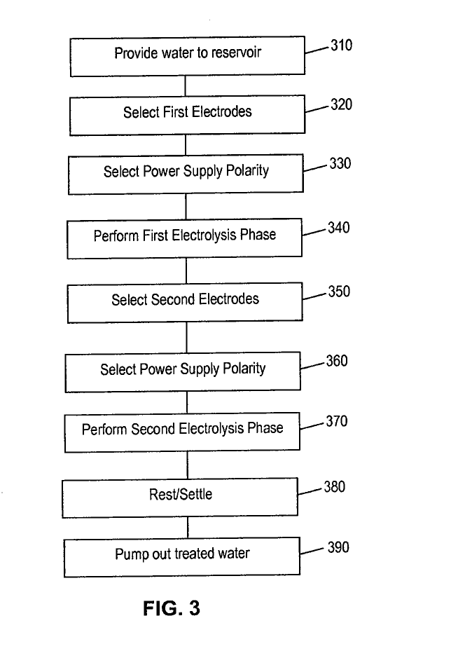

A method and system for performing electroflocculation and electrocoagulation will now be described in more detail with reference to FIGS. 2 and 3. The water to be treated is provided 310 to the treatment system 200 from a raw water source 222. The raw water is pumped from the raw water source 222 into the treatment reservoir 210 using a pump 220. An array of at least two types of primary electrodes 230 is provided within the reservoir 210 and electrically connected to a power supply 234. The primary electrodes 230 are positioned to be at least partially immersed in the water to be treated. The illustrated embodiment includes a plurality of types of primary electrodes each electrode type having a different material composition. Selection of electrodes for use during the electrolysis process can be controlled by a controller. For example, the controller may be implemented as a microprocessor executing a program for controlling the electrolysis process.

The selected electrode pairs are driven using the power supply 234 to perform the electrolysis. Optionally an agitator 260 can be also provided within the reservoir. The agitator 260 may be a set of secondary electrodes, and these may also be connected to the power supply 234 or connected to a separate power supply (not shown) for selection and driving under microprocessor control. Where the agitator 260 is a mechanical stirring device, pump, air compressor etc this may also be connected to an alternative power supply or drive mechanism also under microprocessor control.

After raw water is pumped into the reservoir 310, electrodes are selected 320 for a first electrolysis phase. The polarity for the current to be supplied to the selected electrodes for the electrolysis phase is selected 330 and applied to execute a first electrolysis phase.

Selection of electrodes for use as anodes may be based on the type of electrode and treatment sequence. For example, silver ions are a known lethal agent for microbial organisms such as bacteria and viruses. Copper ions can also be effective for killing algae. Iron and aluminum electrodes produce flocculant/coagulant ions.

Alternatively, the selection of electrodes may be based on the amount and level of contamination of the water and calculated current requirements for the water treatment.

Where not all primary electrodes are required to be activated for an electrolysis phase, the microprocessor may be programmed to select the cathode electrodes to avoid or minimise corrosion, leaving non-corroding electrodes dormant.

Where not all electrodes of one type are required to be used as anodes, the electrodes of the desired anode type may be selected for use based on cumulative use relative to other electrodes of that type. For example, the controller may determine which electrodes have passed the least cumulative total current while used as anodes and select these first. In this way use of the electrodes can be evened out, aiming to maximize the effective life of each anode.

In an embodiment the power supply is a regulated power supply configured for a constant current output. This type of power supply is adapted to automatically adjust output voltage to maintain a constant current. Alternatively, the power supply can be a regulated or unregulated power supply with a primary transformer having a number of output voltages that can be selected automatically or manually. An advantage of being able to provide a constant current or controllable selection of output voltages is that the power supply can be adjusted to enable similar batch processing times despite variations in electrical conductivity of the water. A skilled person will appreciate that the electrical conductivity of the water being treated can vary based on the type and extent of contamination. Having some control over the batch processing time is advantageous for integration of the water treatment into other scheduled processes. Further, less monitoring of the batch processing may be required where the processing time can be reasonably predicted.

In an embodiment, the output voltage and hence output current of the power supply can be adjusted such that there is more power or less power, as required, at different stages in the electrolysis processes. For example, typically higher power will be used at the beginning of treatment for a batch of contaminated water than towards the end of the treatment process.

Depending on the embodiment more than one power supply may be provided, with separate power supplies being used to drive one or more electrodes. The power supplies may be controlled such that the maximum current and hence maximum coagulation of the contaminants occurs at the beginning of the electrolysis phase. The power can then be reduced by switching of one or more power supplies toward the end of the electrolysis phase to reduce the current and hence disturbance of the floc.

The controller also controls operation of the agitator to cause movement of water and any particles and gases therein over the electrodes to aid carriage of ions and impurities away from the electrodes. For example, the agitator may be operated periodically or “pulsed” in some systems. Alternatively the agitator may be operated continuously. The amount of agitation caused can also be controlled. For example, where the agitator is in the form of an underwater fan the rotation speed of the fan may be slowed down or sped up to reduce or increase the amount of agitation. The amount of agitation can be controlled based on the phase of the electrolysis process. The agitator continues or ceases operation also under control of the controller.

The cumulative charge applied during the first phase to power the electrode pairs is measured by the controller. The controller ends the first phase 340 by ceasing to power the electrodes when a cumulative charge threshold based on volume of water treated is reached.

Alternatively the controller can measure the current flow for a short period of time, say 5 seconds, at the start of the electrolysis phase. Based on the measured current the controller can calculate the required duration for the first phase based on the measured current, volume of water and contaminant load. The controller can then set a time for ending the first phase. It should be appreciated that the time for measuring the initial current flow may vary between embodiments. The current flow may also be periodically measured during the electrolysis phase and the duration of the phase adjusted accordingly, if necessary, to compensate for any current fluctuations. It will be appreciated that this will not be necessary where a current regulating power supply is used. Alternatively, where the power supply is not regulated but may be manually adjusted, periodic measurements of current may be taken and the voltage of the power supply adjusted in response to changes to maintain a substantially constant current flow throughout the first phase.

Typically, if the agitator is operated, the controller will continue to operate the agitator for at least a short period of time after the end of the first electrolysis phase to clean the electrodes.

An optional second electrolysis phase may be executed. For example, the first electrolysis phase 340 may be a treatment phase where aluminum or iron anodes were used to flocculate/coagulate contaminants. The second electrolysis phase may then be a sterilization phase adapted for killing bacteria, viruses, microbes or algae which may be present.

For example, sterilization electrodes may be provided within the primary electrode array 230. The material composition of these electrodes maybe based on the purification requirements. For example, copper sterilization electrodes may be provided where algae is a likely contaminant. Silver electrodes may be provided where bacteria, viruses and microbes are likely contaminants. Alternatively, electrodes comprising a combination of silver and copper may be provided to eliminate many live contaminants. For example, where the water is being purified for drinking copper/silver sterilization electrodes may be preferred.

Electrodes 350 and power supply polarity 360 are selected for the second electrolysis phase 370 similarly as above, based on the material composition of the electrodes and the requirements for the electrolysis process. For example, in a post treatment sterilization phase copper/silver electrodes may be driven as anodes.

Alternatively or additionally a further electrolysis phase may be an electrode cleaning phase. For example, where there are noticeable quantities of fats oils and greases (FOGs) in the water the second electrolysis phase may be advantageous. For example, in a system using iron cathode plates for the first electrolysis phase, reversal of polarity causes the iron plates to become anodes releasing ferric ions to capture the FOGs. Operation of the agitator (if provided) is typically continued through this optional second electrolysis phase. Again the controller can monitor the current during the second electrolysis phase and end this phase based on reaching a cumulative current threshold. Alternatively, the controller can measure the current to determine the appropriate duration for the second phase based on the volume of water and contaminant load.

It should be appreciated that any number of electrolysis phases may be executed. Some of these phases may simply comprise reversing polarity of power supplied to already selected electrodes. For example, for electrode cleaning or where only two electrodes are provided in the system. The system may also be adapted to switch back and forth between two electrolysis phases until a given criteria end condition is reached. For example, this may be a measured turbidity threshold, a given number of cycles, a threshold cumulative current value etc.

Once the electrolysis phases are completed the process may include a resting phase 380 wherein the coagulated contaminants are allowed to settle or accumulate on the surface of the water for removal 390. Operation of the agitator will typically be ceased during the resting phase 380 but can also continue, depending upon circumstances. In a system where the contaminants are removed by filtering the resting step may be omitted.

The reservoir 210 illustrated includes a floc chute 214 connected at the top of the reservoir for removal of pollutants from the surface of the treated water 212. The pollutants are removed by introducing clean water to raise the level of the water in the reservoir so that the pollutants flow into the floc chute and away for disposal. The flushing water is provided by pumping water from a flush water reservoir 252 using pump 250 into the treatment reservoir 210. Alternatively, the flushing water may be drawn from a cleaned water reservoir or the flushing water may be from an external source, such as mains water. The treated water is pumped 390 out of the reservoir 210 using pump 240.

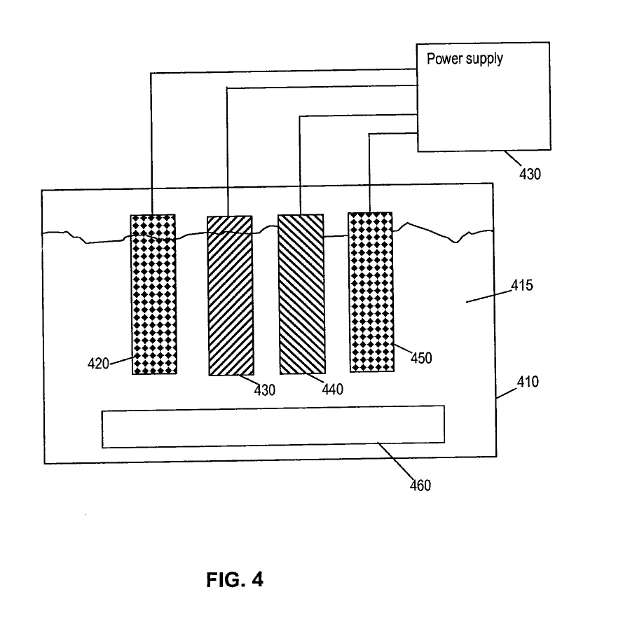

A further example of an electrolysis based water treatment system is illustrated in FIG. 4. The system is similar to that of FIG. 1, comprising a treatment reservoir 410 for holding water 415 to be treated, primary electrode plates 420, 430, 440, 450 arranged in an array at least partially immersed in the water 415 and connected to power supply 470. An optional agitator 460 is also illustrated. The electrode array comprises three types of primary electrodes. The first primary electrode 430 has a first material composition adapted to erode to generate ions when driven as an anode (for example iron). The second primary electrode 440 has a second material composition adapted to erode to generate ions when driven as an anode (for example aluminum). The third type of primary electrodes 420, 440 has a third non-eroding material composition, for example titanium or titanium multi metal oxide (Ti MMO). These non-eroding electrodes are arranged at each end of the array. Providing these additional non-eroding electrodes at the outer ends of the array can aid maximising effective sacrificial electrode life.

Where an outermost plate of an electrode array is driven as a cathode, the outermost surface of this plate behaves as an anode. This can be problematic where a sacrificial electrode is the outermost electrode. For example, as described above in a system having an array of alternating aluminum and iron electrodes all these electrodes are sacrificial. One or the other outermost electrode will at some stage be driven as a cathode, and therefore also release ions. This causes unwanted erosion of the electrode and reduces the effective life of the electrode. Further undesirable consequences could result from the excess ions. For example, encourage growth of iron loving bacteria growth in the case of iron electrodes or undesirable chemical reactions. Using non-eroding electrodes at each end of the array alleviates these problems because these electrodes do not release such ions.

The operation of the electrode plates that are normally polarized as anodes can be further improved by making them smaller than the plates that are normally polarized as cathodes. When the anode plates are the same size as the cathode plates the outer edges of the anode plates provide limited reaction because there are no cathodes directly opposite them. This reduced reaction enables material to build up on the edges, which can eventually interfere with movement of ions, bubbles and water between the plates. Making the anode plates smaller than the cathode plates causes more reaction from the edges and reduces build-up and hence also reduces the subsequent problems. A preferred option is that the anode plates are reduced in size by a ratio equal to the spacing between the anode and cathode plates. However, the invention is not limited to that ratio because any lesser or greater difference in size will have a beneficial effect.

A known problem in electroflocculation and electro-coagulation systems is the electrodes becoming fouled, usually termed clogging, and cease to pass current. In some cases reversal of polarity of electrodes can be used to reduce electrode clogging, but this does not work in all systems.

The water to be cleaned can be pumped into the reservoir through a sprayer. This has the effect of physically dislodging any material on the interior surface of the reservoir and on the electrodes (at least until the electrodes are covered). The electrode plates can also be uniformly cleaned by spraying the water evenly over all the plates. Using a sprayer has an advantage of enabling most if not all electrodes to undergo some cleaning as the water is pumped into the reservoir. In contrast in other systems where the water enters the reaction vessel as a solid stream only some plates or some areas of plates may be cleaned by the stream of water, as the stream does not flow evenly over all of the plates.

Some embodiments of the present invention provide an agitator adapted to cause movement of water, particles and gasses therein to aid carriage of ions and impurities away from the electrodes. An advantage of this movement is that the likelihood of the coagulated impurities adhering to and fouling the electrodes is reduced. In some cases the agitator can also provide a cleaning effect, reducing fouling of the electrodes. The agitator can be any mechanism for causing movement. The agitator may include more than one mechanism for causing agitation of the water and particles and gases therein.

In an embodiment the agitator works to move water within the reservoir. The water movement across the electrodes dislodges material from the electrodes to reduce clogging. For example, the agitator may be a pump or stirring mechanism. The agitator can be adapted to cause the water to circulate between the plates during the first electrolysis phase to reduce the likelihood of material adhering to the electrodes. The agitator may be operated continuously or periodically and the amount of water movement caused may vary based on the electrolysis phase. For example, the agitator may be operated to cause faster movement of water over the electrodes during the treatment electrolysis phases where flocculating/coagulating ions are produced than for phases where flocculation/coagulation is minimal or does not occur. The speed of the water movement for each electrolysis phase may be chosen based on the nature of the chemical reactions anticipated to occur during that phase. For example, the chemical reactions and therefore water movement requirements may change based on the contaminants in the water and the types of materials used for the electrodes.

In an alternative embodiment, the agitator injects a gas into the reservoir. For example, the agitator may inject the gas into the reservoir from below the electrodes to cause a plurality of bubbles to rise up through the water and aid movement of the water through the electrode plates. For example, air can be injected into the reservoir through airstones, fine mesh or perforated tubes. The movement of bubbles over the electrode plates can provide a mechanical cleaning effect, dislodging material deposited on the plates, as well as reducing the tendency of material to adhere to the electrode plates. In an embodiment the agitator includes a plurality of perforated pipes disposed within the reservoir below the primary electrode pairs through which the gas in injected. In some embodiments the gas injected into the reservoir is air. In some alternative embodiments the air may be passed through an ozone generator before being injected into the reservoir. This provides a gas having a significant proportion of ozone which may have sterilization effects as well as air for cleaning the electrode plates.

In a further alternative embodiment the agitator comprises one or more sets of secondary electrodes disposed below the primary electrode pairs and connected to a power supply whereby power provided to the secondary electrodes causes production of bubbles within the water. The secondary electrodes can be non-eroding electrodes which produce small bubbles, also referred to as micro-bubbles, when powered. These micro-bubbles pass through the primary electrode pairs above them to help remove coagulated material from the primary electrode plates. The bubbles result from water in the region around the electrodes changing to a gaseous state. Some bubbles can result from the electric current applied to the secondary electrodes causing decomposition of water (H₂O) molecules into oxygen (O₂) molecules and hydrogen (H₂) molecules which take a gaseous form. Bubbles can also result from ions being generated at the electrodes from the electric charge causing breakdown of water molecules (H₂O) into ions, for example (OH)— and H+ ions. Another cause of bubbles can be localised heating of the water causing it to boil and become gaseous. The type of contaminants in the water being treated can also influence the electrolytic chemical reactions occurring in the region of the secondary electrodes. For example, contaminants affecting the acidity of the water may affect the electrolytic reactions occurring in the region f the secondary electrodes. The mix of gases causing the bubbles can vary between embodiments and even between batched of water being treated. For example, the gases may vary depending on the acidity of the water, current applied and contaminant load in the water. In some instances powering of the secondary electrodes may also cause electrolytic reactions in contaminants which may contribute to the gaseous mixture of the bubbles.

The micro-bubbles can, in some circumstances, also act to free material deposited on the plates of the primary electrode set in a manner similar to that produced when polarity of the primary electrode set is reversed by reducing or neutralizing the affect of electrostatic charge build-up resulting from the generation of positive ions from the anodes. For example, where the pH of the water is greater than 7 the secondary electrode sets generate (OH)— hydroxyl ions from the cathodes and H+ hydrogen ions from the anodes. Thus, these ions can reduce the affect of electrostatic charge.

These ions, in particular the hydroxyl ions, can also have a sterilizing effect as the hydroxyl ions are more reactive than ozone. Further, some chlorine is produced from the reaction between the electrons that provide the electric current through the water and sodium chloride molecules in the water.

In some embodiments more than one agitator may be provided. Depending on the nature of the impurities and contaminants or the load of the contaminants in the water, the secondary set of electrodes only may not be sufficient to inhibit clogging of the electrodes. For example, heavier contaminant particles are less likely to move away from the anode after capture by the coagulating ions. Further, some contaminants are more electrically attracted to the anode than others. In both circumstances reversing polarity of the primary electrodes or relying on the secondary electrodes may not be sufficient. A system may be provided for such circumstances where more than one agitator is provided. For example, a system may be provided with both a set of secondary electrodes and a second agitator for causing circulation of water through the primary electrodes. For example, the second agitator may inject air into the reservoir using airstones or micro-perforated tubing. Alternatively the second agitator may circulate water through the electrode sets using a small pump. Thus, there is a mechanical effect of the bubbles and water movement removing any material that may build up on the primary electrodes. The combined effect of these two agitators can be sufficient to avoid fouling of the primary electrodes. Further, providing circulation of the contaminants through the primary electrodes can improve the bonding of contaminant particles and coagulating ions because previously coagulated particles are moved away form the anodes.

Providing an agitator adapted to cause movement in the water and particles and gases therein to aid carriage of ions and impurities away from the electrodes has a significant advantage in reducing fouling of electrodes in an electrolysis based water treatment system. This, in turn, can significantly reduce the operation and maintenance costs for such systems. Further, the agitator can improve the efficacy of these systems. It should be appreciated that agitators may also be installed in existing electrolysis based water treatment systems to achieve the advantages described above.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or any other country.

1. An electrolysis based water treatment system comprising:
a reservoir for holding the water to be treated;
two or more electrodes of two or more types, each type of electrode having a different material composition, and positioned to be at least partially immersed in water held in the reservoir; and
a power supply adapted to power the electrodes
wherein the electrodes used and the polarity of current applied to power the electrodes for different electrolysis phases are selected based on the material composition of the electrodes.

2. A system as claimed in claim 1 further comprising an agitator operable to cause movement in the water and particles and gases therein to aid carriage of ions and impurities away from the electrodes.

3. A system as claimed in claim 1 wherein the power supply is configured to compensate for varying electrical conductivity of the water to enable constant current to be provided to power the electrodes.

4. A water treatment system comprising:
a reservoir for holding the water to be treated;
one or more first electrodes having a first material composition positioned to be at least partially immersed in water held in the reservoir;
one or more second electrodes having a second material composition positioned to be at least partially immersed in water held in the reservoir;
a power supply adapted to power the electrodes; and
a controller adapted to selectively control the application of power to two or more electrodes selected from the first and second electrodes to perform one or more electrolysis phases, wherein at least one electrolysis phase is an electrolysis treatment phase wherein at least one electrode provides dissolved ions which act as an attractant for impurities to aid removal of the impurities from the water, and wherein the electrodes and power supply polarity are selected for each electrolysis phase based on electrode composition.

5. A system as claimed in claim 4 wherein the selection of electrodes for each electrolysis phase is further based on water treatment requirements and impurities in the water to be treated.

6. A system as claimed in claim 4 wherein the controller is adapted to perform at least two electrolysis treatment phases wherein electrodes having a different material composition are powered as anodes for each electrolysis treatment phase.

7. A system as claimed in claim 6 wherein the electrodes powered as anodes for one electrolysis treatment phase have a material composition including iron and the electrodes powered as anodes for another electrolysis treatment phase have a material composition including aluminum.

8. A system as claimed in claim 7 wherein the electrode powered as an anode in one electrolysis treatment phase is powered as a cathode in another electrolysis treatment phase.

9. A system as claimed in claim 4 wherein the controller is further adapted to perform any one or more of a pre-treatment electrolysis phase and post-treatment electrolysis phase.

10. A system as claimed in claim 9 wherein the first electrodes are sterilization electrodes having a material composition adapted to produce water sterilization ions when powered as an anode for an electrolysis phase.

11. A system as claimed in claim 10 wherein the sterilization electrode is powered as an anode during a post-treatment electrolysis phase.

12. A system as claimed in claim 11 wherein the material composition of the sterilization electrode includes any one or more of copper and silver.

13. A system as claimed in claim 7 wherein the first and second electrodes are plates arranged in an array of alternating first and second electrode plates.

14. A system as claimed in claim 7 wherein the first and second electrode plates are arranged in an array of electrode plates, the array including one or more plates that are not electrically connected to either first or second electrodes or a power supply arranged in the array between at lest two of the first and second electrode plates.

15. A system as claimed in claim 13 further comprising at least two third electrodes having a third non-eroding material composition, wherein the third primary electrodes are arranged at each end of the array of electrode plates.

16. A system as claimed in claim 4 further comprising an agitator operable to cause movement in the water and particles and gases therein to aid carriage of ions and impurities away from the electrodes.

17. A system as claimed in claim 16 wherein the agitator comprises one or more pairs of secondary electrodes disposed below the first and second electrodes and connected to a power supply whereby power supplied to the secondary electrodes causes production of bubbles within the water.

18. A system as claimed in claim 4 wherein the power supply is configured to compensate for varying electrical conductivity of the water to enable constant current to be provided to power the electrodes.

19. A water treatment method comprising the steps of:
providing water to be treated to a treatment apparatus comprising:
a reservoir for holding the water to be treated;
one or more first electrodes having a first material composition; and
one or more second electrodes having a second material composition;
wherein each of the electrodes are positioned to be at least partially immersed in water held in the reservoir and connected to a power supply adapted to power the electrodes,
selecting two or more of the first and second electrodes and a power supply polarity to apply to the electrodes for performing a first electrolysis phase;
applying power of the selected polarity to the selected electrodes to perform the first electrolysis phase;
selecting a further two or more of the first and second electrodes and a power supply polarity for the second electrolysis phase;
applying power of the selected polarity to the selected electrodes to perform the second electrolysis phase; and
removing the impurities from the water,
wherein at least one of the first or second electrolysis phase is an electrolysis treatment phase wherein at least one electrode provides dissolved ions which act as an attractant for impurities to aid removal of the impurities from the water, and
wherein the electrodes and power supply polarity are selected for each electrolysis phase based on electrode composition.

20. A method as claimed in claim 19 wherein the selection of electrodes for each electrolysis phase is further based on water treatment requirements and impurities in the water to be treated.

21. A method as claimed in claim 19 wherein electrodes having a different material composition are powered as anodes for each electrolysis treatment phase.

22. A method as claimed in claim 21 wherein the electrodes powered as anodes for one electrolysis treatment phase have a material composition including iron and the electrodes powered as anodes for another electrolysis treatment phase have a material composition including aluminum.

23. A method as claimed in claim 22 wherein the electrode powered as an anode in one electrolysis treatment phase is powered as a cathode in another electrolysis treatment phase.

24. A method as claimed in claim 19 wherein at least one electrolysis phase is a pre-treatment electrolysis phase or post-treatment electrolysis phase.

25. A method as claimed in claim 24 wherein the first electrodes are sterilization electrodes having a material composition adapted to produce water sterilization ions when powered as an anode for an electrolysis phase.

26. A method as claimed in claim 25 wherein the sterilization electrode is powered as an anode during a post-treatment electrolysis phase.

27. A method as claimed in claim 26 wherein the material composition of the sterilization electrode includes any one or more of copper and silver.

28. A method as claimed in claim 19 wherein the treatment apparatus further comprises an agitator and the method further comprises the step of operating the agitator during at least the electrolysis treatment phase to cause movement in the water and particles and gases therein to aid carriage of ions and impurities away from the electrodes.

29. A method as claimed in claim 29 wherein the agitator comprises one or more sets of secondary electrodes disposed below the first and second electrode pairs and connected to a power supply whereby power supplied to the secondary electrodes causes production of ions and bubbles within the water.

30. A method as claimed in claim 19 wherein the step of performing the electrolysis treatment phase includes the steps of measuring the current flowing through the electrodes at the beginning of the first phase to power the electrode pairs, calculating a duration for the first phase based on the measured current, volume of water and contaminant load of the water, and ending the first phase after the calculated duration by ceasing to power the electrodes.
